(19) United States
(12) Patent Application Publication
(10) Pub. No.: US 2013/0085885 A1
(43) Pub. Date: Apr. 4, 2013

(54) SYSTEM AND METHOD FOR A PHOTOVOLTAIC PLANT MARKET EXCHANGE

(71) Applicant: Neozyte, Palo Alto, CA (US)

(72) Inventors: Anil Kumar Sahai, Saratoga, CA (US); Paul N. Wyatt, San Carlos, CA (US); Laks M. Sampath, Corte Madera, CA (US)

(73) Assignee: Neozyte, Palo Alto, CA (US)

(21) Appl. No.: 13/632,883

(22) Filed: Oct. 1, 2012

Related U.S. Application Data
(60) Provisional application No. 61/540,804, filed on Sep. 29, 2011.

(51) Int. Cl. G06Q 50/06; G06Q 30/00

(52) U.S. Cl. CPC G06Q 50/06; G06Q 30/0611; G06Q 30/016
USPC 705/26.4; 705/304

(57) ABSTRACT

Systems and methods for providing a photovoltaic market exchange that permits registered users to create a request for quote (RFQ) for photovoltaic plant services, receive current RFQs, or submit a bid on an RFQ are disclosed. In one embodiment, the market exchange provides a contract management system. In one embodiment, the market exchange is integrated with a plant asset management platform that is configured to evaluate various aspects of a photovoltaic plant ecosystem.

### CROSS-REFERENCES TO RELATED APPLICATIONS

This application claims the benefit of the following application which is incorporated by reference in its entirety, U.S. Provisional Application No. 61/540,804, entitled “SYSTEMS AND METHODS FOR A PHOTOVOLTAIC PLANT MARKET EXCHANGE”, filed Sep. 29, 2011.

This application is related to U.S. patent application Ser. No. 13/453,891, entitled “SYSTEMS AND METHODS FOR A PHOTOVOLTAIC PLANT ASSET MANAGEMENT”, filed Apr. 23, 2012, and is hereby incorporated by reference in its entirety.

### BACKGROUND

A photovoltaic plant is made up an array of photovoltaic modules that are powered by irradiance from the sun. However, the actual irradiance received by photovoltaic modules at the plant varies depending upon the weather and other environmental factors. Because of the variability of the amount of irradiance reaching the photovoltaic modules, problems arising in the modules can be masked.

Photovoltaic plant owners are often faced with the task of maintaining their plants. Some photovoltaic plants have monitoring systems that generate alarms but many times cannot identify the problems that caused the alarms. Thus, the owners are left with the task of identifying the problems that cause a reduction in generation of energy. Further, they have to search for a qualified service provider to repair the problem at a reasonable cost, thus creating financial and operational risks.

### BRIEF DESCRIPTION OF THE DRAWINGS

Examples of a photovoltaic (PV) plant asset management system and photovoltaic plant market exchange are illustrated in the figures. The examples and figures are illustrative rather than limiting.

FIG. 1A shows example interactions between an asset management platform and various components that can impact operation of the PV plant.

FIG. 1B shows a block diagram of an example system that implements a unified PV plant asset management platform.

FIG. 1C shows a diagram illustrating example flows of data, jobs, and decisions with respect to the PV plant asset management platform.

FIG. 2A shows locations of typical month year (TMY) weather stations relative to a proposed PV plant site.

FIG. 2B shows how air mass index differences arise for when the sun is directly overhead and when the sun is no longer directly overhead.

FIG. 3 shows pictorially how global horizontal irradiance (GHI), diffuse horizontal irradiance (DHI), and direct normal irradiance (DNI) are obtained.

FIG. 4 shows a PV array comprising three parallel three-module strings and the I-V curve for the array if the modules each had identical performance characteristics.

FIG. 5 shows how production losses are estimated in stages for a PV plant.

FIG. 6 depicts a flow chart illustrating an example process for making decisions regarding plant activities based on a financial model.

FIG. 7 shows a diagrammatic representation of a machine in the example form of a computer system within which a set of instructions, for causing the machine to perform any one or more of the methodologies discussed herein, may be executed.

FIG. 8 shows a diagram illustrating example interactions with a market exchange and other elements of a unified photovoltaic plant asset management platform.

FIG. 9 illustrates an example diagram of a system where a photovoltaic plant market exchange server supports interactions between different stakeholders operating in the solar industry.

FIG. 10 depicts a block diagram illustrating an example of components in the NeoZyte Market Exchange server that supports the NeoZyte Market Exchange.

FIG. 11 depicts a block diagram illustrating an example of components in the contract management engine.

FIGS. 12A and 12B depict a flowchart illustrating an example process of receiving an RFQ for distribution to service providers and receiving RFQ quotes.

### DETAILED DESCRIPTION

A photovoltaic market exchange is described that can facilitate interactions among photovoltaic plant owners, original equipment manufacturers (OEM), engineering, procurement, and construction (EPC) companies, and service providers. A registered user with the market exchange can create a request for quote (RFQ) for services, receive the RFQs for placing a bid, submit a quote for an RFQ, and request more information pertaining to an RFQ.

The photovoltaic market exchange is part of a plant asset management platform that can evaluate various aspects of a photovoltaic plant ecosystem, for example, the interactions between the plant owner, the plant operators, plant revenue sources, plant financers, the utility, original equipment manufacturers (OEMs), weather data providers, service providers, and plant data monitoring services. The platform provides recommendations on plant management, operations, and maintenance decisions based upon plant objectives, obligations, and production metrics. The platform can also evaluate complex trade-offs using complex analytics.

Various aspects and examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

Unified Photovoltaic Plant Asset Management Platform

A typical photovoltaic (PV) plant ecosystem is complex: revenue is derived from multiple sources; financing is provided by multiple sources with different repayment rules and covenants; the local utility and balancing authority place requirements on operations; multiple parties supply warrantied equipment, materials and workmanship; and multiple parties provide management, operations and maintenance services. Fragmented plant management authority and responsibility result in sub-optimal plant performance.

Typically, plant management responsibilities are split among multiple departments with no clearly identified authority. For example, plant operations oversees the operations and maintenance (O&M) service providers and plant monitoring, project finance oversees the obligations to project financers, and corporate finance provides billing services. However, plant operations are only a portion of the responsibilities for each of these departments. The total set of obligations to the parties connected to the PV plant is not clearly identified, and the plant management metrics are not established.

In some cases, an asset manager may be assigned the responsibility and authority for plant management. While the asset manager may coordinate the efforts of the different departments directly responsible for managing the services, he does not have the information or tools necessary to evaluate the impact of decisions made concerning the plant on the full set of plant obligations to make informed trade-offs.

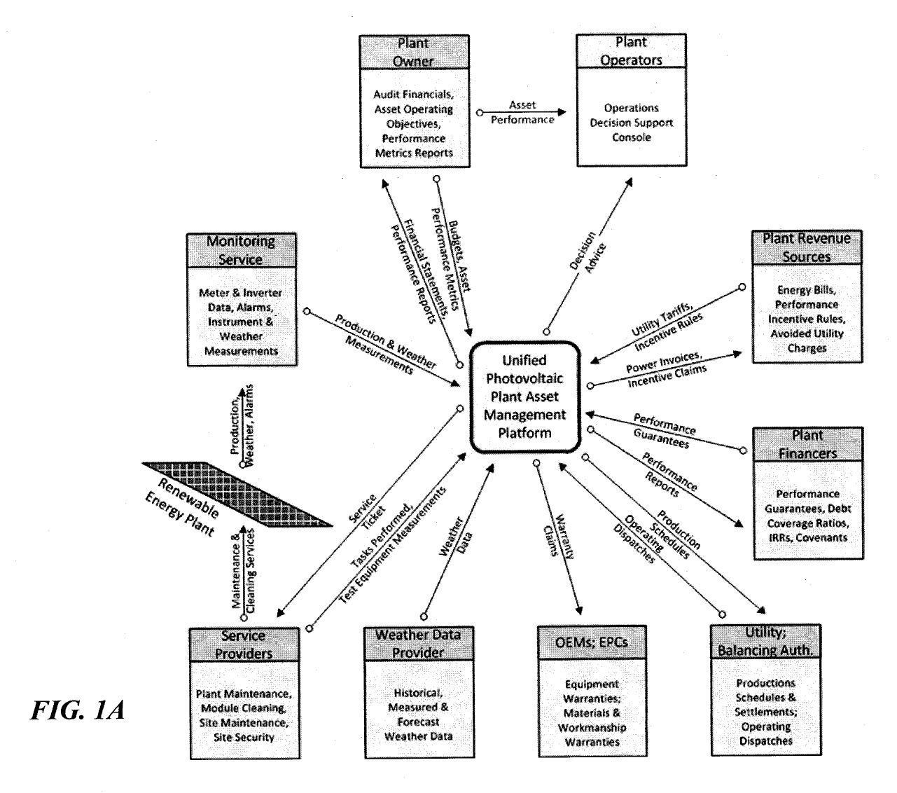

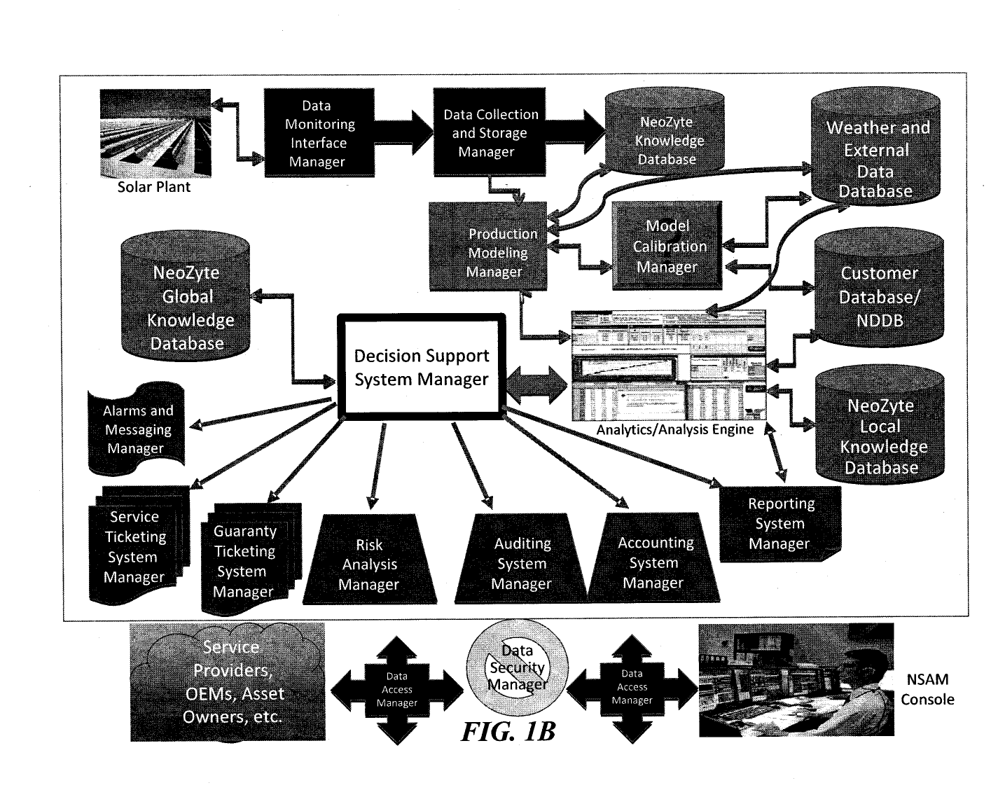

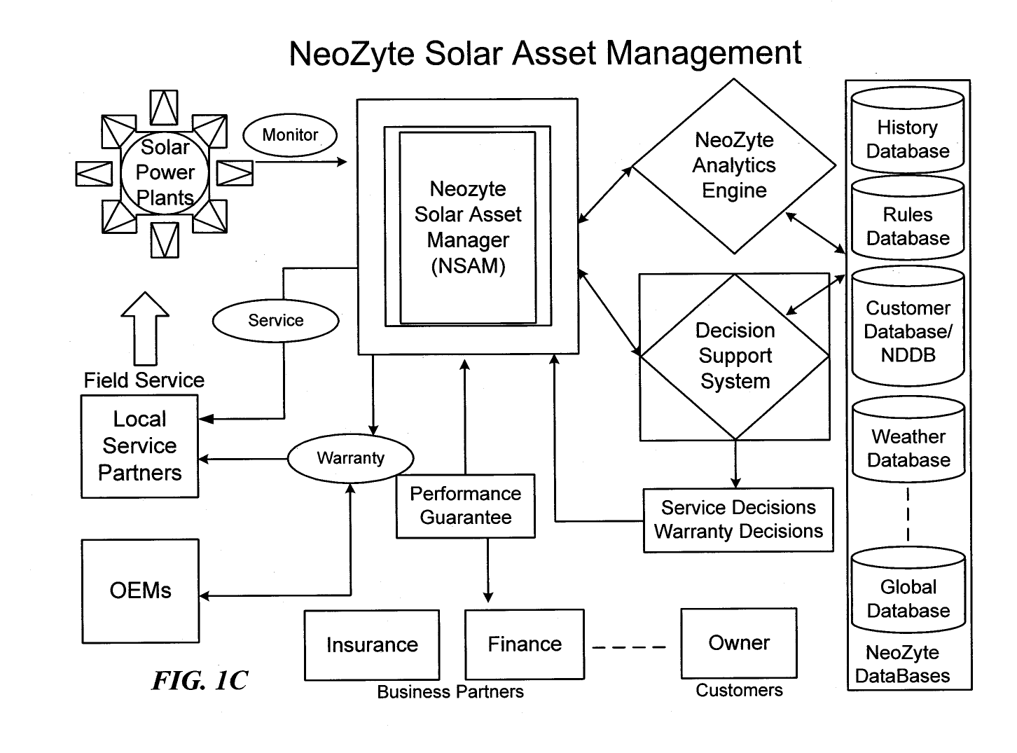

In one embodiment, a PV plant asset management platform can be implemented that encompasses the entire plant ecosystem and contains asset objectives with metrics. FIG. 1A shows example interactions between the asset management platform and various components that can impact operation of the PV plant. Plant management, operations and maintenance decisions can be based on an overarching set of objectives, obligations and production metrics, and the platform can evaluate complex trade-offs that are not practical with disparate management tools.

As shown in the example of FIG. 1A, the platform can base plant management advice on complex analytics of components impacting different aspects of the PV plant and optimize trade-offs between the different aspects. For example, a weather forecast of rain might lower the revenue impact of a repair; an annual debt-coverage-ratio might influence the decision to dispatch a cleaning crew; and the production schedule submitted to a balancing authority might delay inverter cleaning.

The platform can include, but is not limited to, the following elements: weather resources, plant measurements from monitoring services and on-site tests, as-built production model, metrics-driven plant valuation model, performance advanced analytics engine, contracts management with obligations, equipment database with specifications and warranties, services provided with services and costs, plant revenue sources and avoided utility tariffs, plant budgets and financials, and plant maintenance obligations and records.

FIG. 1B shows a block diagram illustrating an example system, the NeoZyte Solar Asset Manager (NSAM), that implements the unified PV plant asset management platform. In one embodiment, the NSAM system can include the following modules: NeoZyte Solar Asset Manager Console (NSAMC), Data Monitoring Interface Manager (DMIM), Data Collection and Storage Manager (DCSM), Production Modeling Manager (PMM), Model Calibration Manager (MCM), Analytics/Analysis Engine (AAE), Decision Support System Manager (DSSM), Service Ticketing System Manager (STSM), Guaranty Ticketing System Manager (GTSM), Data Access Manager (DAM), Alarms and Messaging Manager (AMM), Data Security Manager (DSM), Reporting System Manager (RSM), Accounting System Manager (ASM), Risk Analysis Manager (RAM), Auditing System Manager (ADSM), NeoZyte Knowledge Database (NKDB), Local Knowledge Database, Global Knowledge Database, Weather and External Data Database, Customer Database. Additional or fewer modules may be included.

NeoZyte Solar Asset Manager Console (NSAMC)

This module provides the administrator interface to the NSAM, and it can be accessed locally as well as remotely through the Internet, directly connected to a network (either wired or wirelessly), accessible by, mobile phone, or other means. In one embodiment, access to the NSAM thru NSAMC is only available to the NSAM's authorized administrators and other authorized users. Access can be controlled by one or more security measures including dual authentication measures, passwords, etc.

Data Monitoring Interface Manager (DMIM)

This module provides an open standard interface (I/F) for integration with monitoring systems that collect real time data from a solar plant. The I/F can incorporate any sets of data fields (e.g., XML like) and can communicate with the monitoring systems over any standard communication network (e.g., wired or wireless) using a variety of network protocols.

Data Collection and Storage Manager (DCSM)

This module collects data from monitoring systems using the DMIM, and stores the data in an appropriate format for use off-line. This module allows on-line analytics and analysis, and provides the data to other modules like reporting, accounting, auditing, decision support, etc. in NeoZyte Data Database (NDDB). The NDDB contains plant measurements collected from sensors and other plant instrumentation. The data can be collected using a monitoring system or directly from the plant using test equipment.

Production Modeling Manager (PMM)

This module uses proprietary algorithms to model and compute the expected production from the solar plant under service. It uses the existing design and architecture of the solar plant including its components, weather data, other monitored data collected by DCSM (including real time data as well as collected historical data), Typical Meteorological Year (TMY) data, local weather data, etc. This module can also access information in the NeoZyte Knowledge DataBase (NKDB). A variety of production attributes are stored online in the NKDB as well as off-line analytics, analysis, reporting, accounting, auditing, etc. The NKDB is described in more detail below.

Model Calibration Manager (MCM)

This module continuously compares the model output data with the monitored data and stored data using a variety of regression analysis techniques and updates the model. This module can also update/upgrade/modify the PMM using a class/SET of “optimization objectives” for Decision Support System (DSS).

Analytics/Analysis Engine (AAE)

This module uses a variety of inputs, such as monitored data (real time as well as stored), TMY data, local weather data, (real time as well as historical data sets from DCSM), as well as output from the PMM to produce a set of metrics to be used by the Decision Support System Manager (DSSM) using a variety of NeoZyte's proprietary algorithms. The module also communicates with the NKDB to store and retrieve any relevant data.

Decision Support System Manager (DSSM)

This module analyzes the data/results received from the AAE to perform functions including identifying production anomalies, identifying if any of the PV plant components and/or modules are not performing according to a set of “optimization criteria”, developing a set of corrective actions, such as initiating a service ticket, requesting warranty service, sending out an alarm, e-mail, or warning for corrective action, etc.

Service Ticketing System Manager (STSM)

This module is the “Integration Point” with the service provider's network and implements the “service ticket” job flow. Based on the action recommendation from the DSSM, this module issues a service ticket to be processed by the service provider relevant to the problem for the solar plant under service.

The STSM manages the life of the ticket until the problem is resolved. Information that may be included and/or tracked as part of a service ticket includes type of problem, time, component involved, current status; type of corrective action; name and details of the service provider(s) to handle the ticket; alarms and messages to the relevant internal and external agents; exception handling processes/steps; when the ticket was received and admitted by the service provider; what the corrective action was and when the corrective action was initiated; when and what action was taken; the cost of the corrective action; alarms and messages to the relevant internal and external agents intimating the completion of the ticket service request. Intermediate process steps associated with handling of the service ticket can be recorded and stored for future analysis, accounting, auditing, reporting, etc. The STSM can also manage exception handling.

Guaranty Ticketing System Manager (GTSM)

This module is the “Integration Point” with the original equipment manufacturers (OEM) and the service providers' network. The GTSM implements the “guaranty ticket” job flow. Based on the action recommendation from the DSSM, this module issues a service ticket to be processed by the service provider and/or possibly by the OEM partner relevant to the problem for the solar plant under service.

The GTSM manages the life of the ticket until the problem is resolved. Information that may be included and/or tracked as part of a guaranty ticket includes type of problem, time, component involved, current status; type of corrective action; name and details of the OEM and service provider(s) to handle the ticket; alarms and messages to the relevant internal and external agents; exception handling processes/steps; when the ticket was received and admitted by the OEM and service provider; what the corrective action was and when the corrective action was initiated; whether a part/component needs to be replaced from the OEM, a job flow for the part replacement from the OEM or relevant “inventory handler” is initiated and managed; when and what action was taken; the cost of the corrective action; creation of a bill for collection from the OEM or the asset owner; alarms and messages to the relevant internal and external agents intimating the completion of the ticket service request. Intermediate process steps of guaranty ticket handling are recorded and stored for future analysis, accounting, auditing, reporting, etc. The GTSM can also manage exception handling.

Data Access Manager (DAM)

This module provides a data access interface to the data stored by the DCSM as well as the NKDB for internal and external requests. In one embodiment, an open interface (e.g., XML like) is provided to receive data requests from any application over any communication medium (wired/wireless/mobile).

Alarms and Messaging Manager (AMM)

This module issues alarms and sends appropriate messages to internal and external agents based on the data produced by the DSSM. These alarms and messages can be communicated over a variety of media (wired/wireless/mobile) using a variety of formats including open communication standards. Messages/alarms are stored for future analysis/reporting/auditing/accounting etc. in the NKDB.

Data Security Manager (DSM)

This module provides the security interface and control for any data access request from internal and external agents to/from the NDDB and NKDB. Access rights can be stored in a directory server type of database for access to data and logs for reporting/accounting/auditing/etc.

Reporting System Manager (RSM)

This module creates custom and periodic reports for scheduled and other requests. These reports can be generated in an open format (eg., XML like) using the NDDB and NKDB and can be transmitted periodically, scheduled or on request over a variety of communication media (wired/wireless/mobile).

Accounting System Manager (ASM)

This module keeps accounting and billing for different kinds of service tickets, guarantee services, data usage, production data and its price/cost/volume, etc. in real time as well as processes for off-line tabulation/aggregation/summary/etc.

Risk Analysis Manager (RAM)

This module uses a variety of objectives (set and configurable by a NSAM administrator and/or an authorized user) for the solar plant under service to evaluate “performance guarantees” vis-à-vis operating/service request cost; evaluate which service requests are to be issued and which requests are to be deferred (i.e., create priority queues for requests generated by DCSM for STSM); optimize operating costs of the solar plant under service; create custom and scheduled risk management analysis and reports. Outputs of the RAM can be stored in the NKDB for future analysis, reporting, accounting, auditing, etc.

Auditing System Manager (ADSM)

This module provides the capability to audit the activities of the NSAM modules including analysis, product model data history, monitored data history, tickets history/job flow, reports generated, accounting, responsible parties, user access, etc.

NeoZyte Knowledge Database (NKDB)

In one embodiment, the NKDB can include information from two databases, a Local Knowledge Database and a Global Knowledge Database. The Local Knowledge Database develops and maintains a database of actions, recommendations, analysis and analytics, models, service and guaranty tickets, costs, optimization criteria, reports, etc. to be used by other modules of the NSAM. The database evolves as more data is analyzed and new/corrective actions are taken, optimizations are developed, etc. for the solar plant under service. The Global Knowledge Database is an aggregation of the Local Knowledge Databases for different solar assets managed by the NSAM. It can contain additional optimization rules, analytics and analysis, historical data as well as regression analysis reports that can be used to optimize operations efficiency and optimize risk management for performance guarantees.

Weather and Other External Data Database

This database stores the weather data relevant to the solar plant under service along with any external data that may be relevant and used by NSAM to operate effectively.

Customer Database

This database contains detailed information of the solar plant under service, for example, solar plant identification and owner contact information; emergency contact information; accounting and billing details and interfaces; solar plant design and architecture details including components and modules (model/capacity/serial number/date installed/warrantees/repair history/location/etc.).

The unified PV plant asset management platform provides a unique and structured approach to optimized management of solar assets by combining real time monitored data, accurate production modeling using proprietary and field proven analytics and an integrated service ticketing system that automatically issues necessary service requests to the designated service provider. Benefits of the platform include an open data interface architecture that can allow any monitoring system at a solar plant to be integrated with the management solution platform; a scalable asset management solution for operations and maintenance of almost any industrial plant, and, in particular, solar plants; and automatic problem identification, integration with a network of qualified service providers and real time “ticketing with job flow management” to provide the lowest cost of maintenance with the quickest response time.

The automatic, accurate and calibrated modeling results combined with real time analytics provides quick identification of problems at a solar power plant (i.e., root cause identification leading to quick problem resolution through the integrated services network for reactive maintenance, resulting in significant production savings).

The automatic, accurate and calibrated modeling results combined with real time analytics using a variety of regression analysis techniques on historical data provides quick identification of problems as they develop at a component level at a solar power plant, thus leading to quick problem resolution through the integrated services network for predictive maintenance, resulting in significant production savings.

The underlying DSSM working in tandem with the AAE, real time data, historical data and the local and global knowledge databases optimizes operations and maintenance decisions with respect to a set of criteria for overall cost minimization and revenue maximization for the solar plant, thus eliminating financial risks from operational inefficiencies in the solar industry.

FIG. 1C shows a diagram illustrating example flows of data, jobs, and decisions with respect to the NSAM. In one embodiment, the NSAM has a business relationship with the plant owner, and the plant owner may in turn have business relationships with different partners, for example, financers and insurers. In one embodiment, the plant owner may be contractually obligated to guarantee plant performance to one or more of the partners, and the NSAM analyzes the different relationships between various aspects of managing the plant to optimize the plant's performance and advises the plant owner on how best to meet performance guarantees. In one embodiment, the NSAM monitors the solar power plant and gathers relevant data relating to the equipment and operations of the plant. The NKDB includes a history database, a rules database, a customer database, a weather database, and a global database. The rules database includes principles to be applied in certain situations and rules learned form experience that can be used to optimize the operation of the plant. In one embodiment, the AAE in conjunction with the NKDB can evaluate the data and determine tradeoffs between different courses of action and arrive at decisions for optimizing the operation of the plant. In one embodiment, the DSSM in conjunction with the NKDB can make service-related decisions and warranty decisions. For example, if the equipment is not operating as specified by warranties provided by the OEM, a request is made for warranty service to the appropriate OEM or a service ticket is dispatched to a local service partner to provide field service to the plant at an optimum time for the plant. Examples of functions performed by the NSAM to arrive at decisions are described in detail below.

As used herein, a “module,” a “manager,” or an “engine” includes a general purpose, dedicated or shared processor and, typically, firmware or software modules that are executed by the processor. Depending upon implementation-specific or other considerations, the module, manager, or engine can be centralized or its functionality distributed. The module, manager, or engine can include general or special purpose hardware, firmware, or software embodied in a computer-readable (storage) medium for execution by the processor. As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

Weather—Statistical Weighted Correlation of Site-Measured Weather to Nearby Historical Weather.

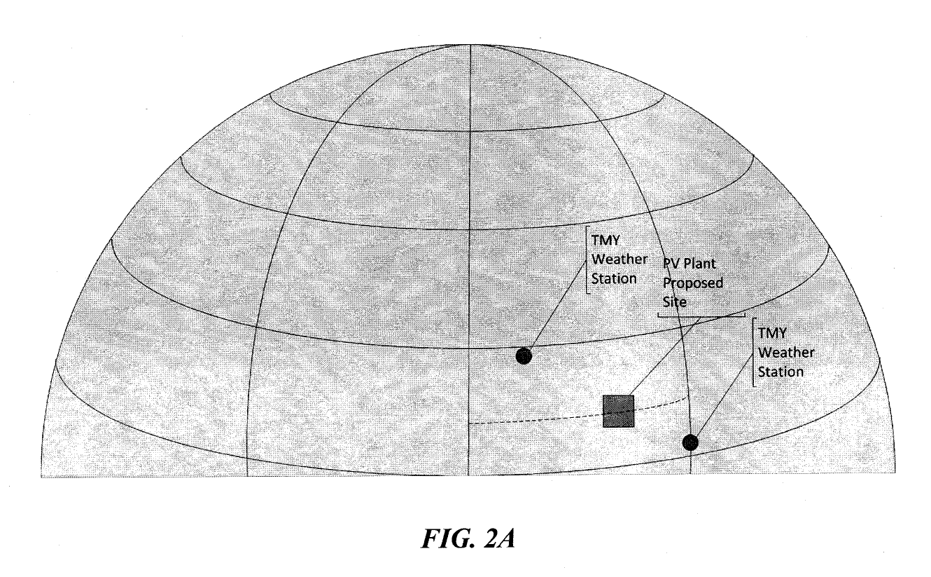

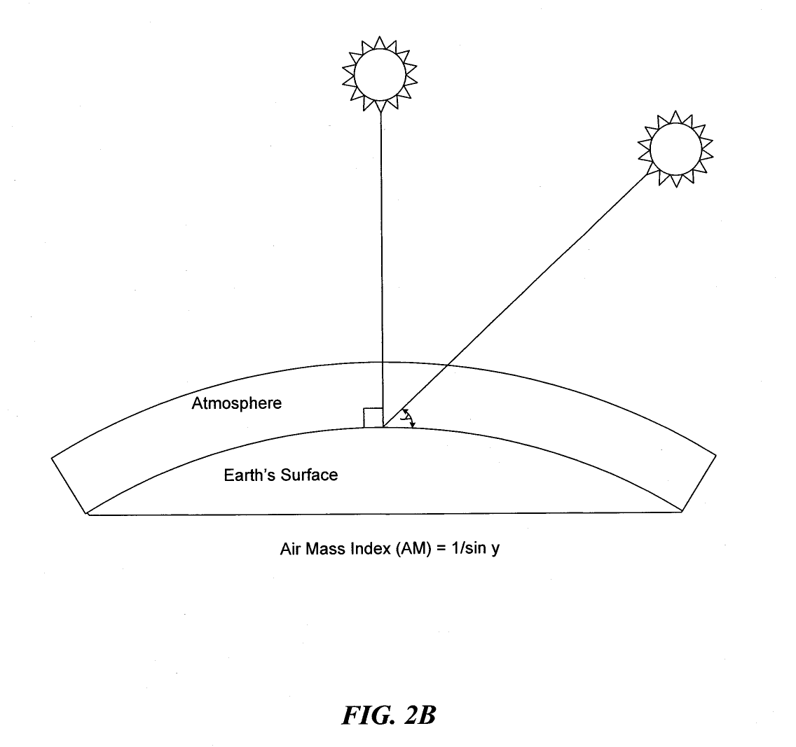

Historical, statistics-based weather data, such as typical month year (TMY) weather data, used to estimate PV plant electricity production is sourced from the nearest weather station(s) which can be many miles away from the PV plant. (See FIG. 2A) It takes many years of weather data, up to 30 years or more, to derive sufficient statistical data so it is not practical to install a weather station at the plant location to derive more accurate statistical weather data.

Traditionally, TMY weather data is sourced for a nearby weather station from a public or private data source and adjusted to the latitude and elevation of the PV site. If the distance from the closest weather station is large, and two weather stations are available, data from both stations might be used and adjusted to help validate the interpolation. In feasibility analysis, the performance risk is adjusted based on the confidence in and standard mean deviation of the weather data.

The fuel that powers a PV plant is irradiance from the sun. Air mass and air clarity are the primary variables that can cause irradiance to vary at different locations that are at the same latitude. Air mass index is the ratio of the mass of atmosphere through which the solar radiation beam passes to the mass it would pass through if the sun were directly overhead. (See FIG. 2B) As the air mass increases, the spectral content of irradiance changes.

Air clarity is the extent to which the Earth's atmosphere transmits solar radiation. The atmosphere's clarity varies widely, depending on the amount of absorbing material such as water vapor, dust, aerosols (suspended fine particles), and polluting gases. In some instances, private weather data providers can use satellite cloud data from recent years to adjust weather clarity data for a site location. Air clarity and the spectral content of the light affect the direct and diffuse irradiance in the PV plane-of-array.

One solution for improving PV plant electricity production estimates is to install a weather station at the plant location and use appropriate mathematical processes to correlate the measurements taken at the plant location with measurements taken at nearby TMY weather station(s). Using as little as one year of data correlations, it is possible to accurately derive plant TMY weather data from the nearby weather station(s) TMY data, thereby improving PV plant electricity production estimates.

Interpolating the site weather data from known nearby weather data sets can account for latitude and elevation differences. Additionally, satellite data can be used to approximate air clarity from cloud cover resulting in accuracies that are sufficient for feasibility analysis but not for plant production management. Adjustments for water particles, dust, aerosols, and polluting gases in the air should be made to improve accuracy, especially during the times-of-day and times-of-year when the low sun angle increases the air mass, resulting in reduction of both irradiance and the usable light spectrum.

In one embodiment, the accuracy of the historical weather data for the site can be increased through Bayesian statistical methods that use direct evidence combined with collateral historical data. By combining on-site weather measurements with adjusted TMY data using assigned weights, accuracy can be continually improved as the weighting shifts from historical data to measured data over time. When no direct measurements have been taken, the weight for this data is zero and only historical data is used. When more and more measured data becomes available, the weight of the measured data increases to and becomes closer and closer to one.

In one embodiment, equations (1) and (2) below can be used to calculate the weights to be used for the on-site weather measurements and the historical data.

$$\begin{matrix}E = ω \cdot \frac{x}{n} ( 1 - ω ) \cdot \overline{ρ} , & ( 1 ) \\ ω = \frac{n}{n + \frac{\overline{ρ} ( 1 - \overline{ρ} )}{{σ}_{ρ}^{2}}} - 1 , & ( 2 )\end{matrix}$$

where E is the estimated site days with >1 standard deviation, ρ̅ is average proportion of TMY-based days with >1 standard deviation, σ_{ρ} is the standard deviation of TMY-based days, ω is the weight of the site-measured data, χ is the number of site-measured days with ≦1 standard deviation, and n is the number of site-measured days. It will be appreciated that other weights between the on-site weather measurements and the historical data can be used. In one embodiment, the weights can be non-linear and/or adjusted for other variables, such as those impacting the weather data.

Weather—Statistical Weighted Correlation of Site-Measured Global Horizontal Irradiance to Plane of Array Irradiance Relationship Used to Correct Historically Forecast Relationship

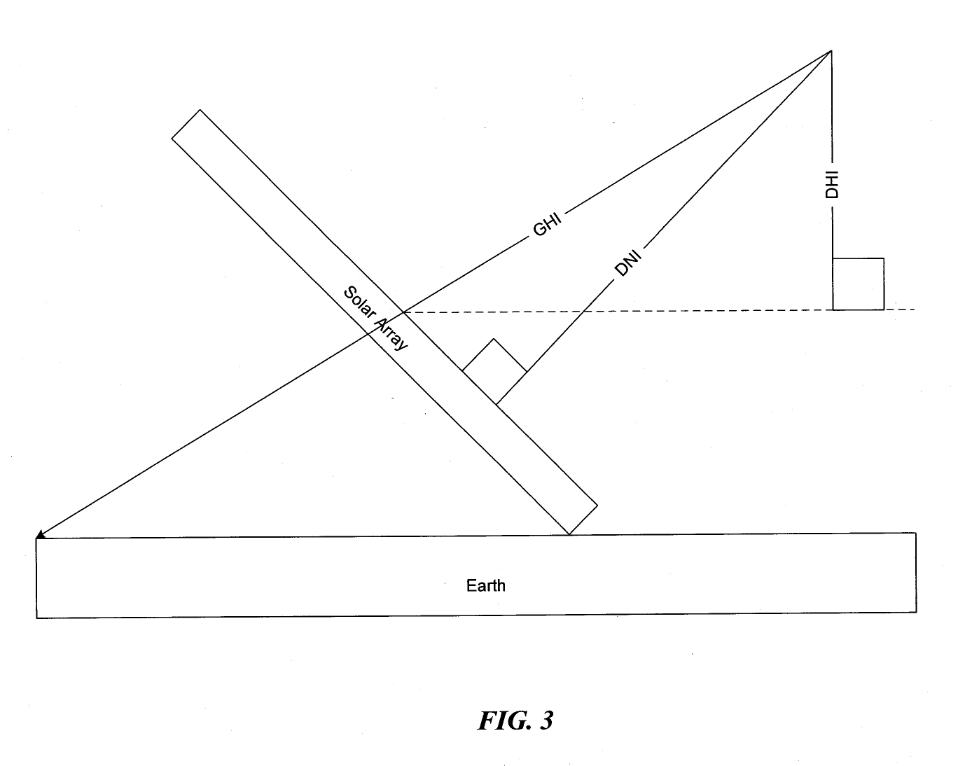

Global Horizontal Irradiance (GHI) is a measure of solar radiation incident on a horizontal surface from all possible angles. It is the total solar radiation; the sum of direct, diffuse, and ground-reflected radiation. However, because ground reflected radiation is usually insignificant compared to direct and diffuse radiation, for all practical purposes global radiation is said to be the sum of direct and diffuse radiation only. Plane of array (POA) irradiance is the irradiance striking the surface of a solar module, which includes both direct normal irradiance and diffuse horizontal irradiance, and is measured in watts per square meter (W/m²). Diffuse Horizontal Irradiance (DHI) or diffuse sky radiation is the radiation component that strikes a point from the sky, excluding Direct Normal Irradiance (DNI). In the absence of atmosphere, there should be almost no diffuse sky radiation. High values are produced by an unclear atmosphere or reflections from clouds. Direct Normal Irradiance (DNI) or direct sky radiation is the solar irradiance measured at a given location on Earth with a surface element perpendicular to the Sun's rays, excluding Diffuse Horizontal Irradiance. DNI is equal to the solar constant minus the atmospheric losses due to absorption and scattering. TMY hourly weather data used to estimate PV plant electricity production does not include irradiance data taken in the plane of the PV array (POA). Only global horizontal irradiance (GHI) data is measured and provided with the TMY data. (See FIG. 3) Various applications that are currently available for estimating PV production calculate POA irradiance from GHI using different algorithms that are often not disclosed.

Academic research conducted on calculating plane-of-array irradiance from GHI and other weather data has resulted in at least four different models that are currently being used within the PV industry. Studies by numerous laboratories point out the strength and weakness of each of the models, but outputs from the models are no better than the data used as inputs to the models. When a PV system is to be sited at a location that does not have TMY data available at the site, the TMY data must be estimated by interpolating data from a nearby weather station(s), as described above. When estimated weather data is used to estimate plane-of-array irradiance, the inaccuracy is compounded. Because plane-of-array irradiance is the most important factor in computing energy production, the chain of inaccuracies greatly increase the risk of miscalculating electricity production by the PV plant.

In one embodiment, measured data from the PV plant site can be used to adjust historical data and to correct the POA calculation obtained from measured GHI. A weather station is installed at the plant location that measures both GHI and POA irradiance. The measured weather data is entered into a production estimation application to calculate the estimated POA irradiance from the measured GHI. The calculated POA is then compared to the measured POA, and the deviation measured. The deviation is used with a Bayesian statistics method to adjust the historic POA data. As more measured data becomes available, the weight given to the measured deviation increases closer to one. Estimates made by the production estimation application can be adjusted to match the conditions measured at the PV plant location to improve PV plant production estimates.

Production—As-Built PV Plant Model Plus I-V Curve Measurements Used to Separate Weather-Based Production Variance from Equipment-Based Production Variance

The “fuel” used by PV plants to produce electricity is solar irradiance. The amount of available fuel varies, not just from day to day but from moment to moment. The variability of solar irradiance makes it difficult to calculate expected plant production over short periods of time, and without accurate expected production it is difficult to determine if the plant is operating as designed and fully utilizing the available fuel. Production variations due to weather obscure other production problems.

Weather deviation for a specific period of time sets the expected plant production measurement tolerance. If the TMY weather deviation for a one month period is 20 percent and the deviation for a one year period is 10 percent, then end-of-month analytics within 20 percent of forecast and end-of-year metrics within 10 percent of forecast do not raise significant concern. Semi-annual or annual scheduled maintenance tests are used to detect failures that are not detected by the monitoring systems and production analysis tools.

All commercial- and utility-scale PV arrays have PV modules connected in series and parallel combination. Although the most common configuration at this time is N-strings in parallel with each string containing M-modules in series, research has shown that cross-tied and bridged connections increase array production. The reason for this research and resultant methods for connecting PV modules into arrays is to minimize the effect of module mismatch as specified by Kirchhoff's Laws.

For modules connected in series, the following equations apply:

Current(Iₜₒₜₐₗ)=I₁=I₂=I₃ . . . =Iₘ

Voltage(Vₜₒₜₐₗ)=V₁+V₂+V₃ . . . +Vₘ

The current for the series equals the current of the module producing the lowest current. The voltage for the series equals the sum of the voltage produced by each module. Consequently, a module producing low current not only establishes the current for the series, but the excess current produced by the other modules is dissipated as heat by the low-performing module increasing the chance for a failure.

For modules connected in parallel, the following equations apply:

$$Current ( {I}_{total} ) = {I}_{1} + {I}_{2} + {I}_{3} … + {I}_{n}$$

$$Voltage ( {V}_{total} ) = \frac{{V}_{1} + {V}_{2} + {V}_{3} … + {V}_{n}}{n} .$$

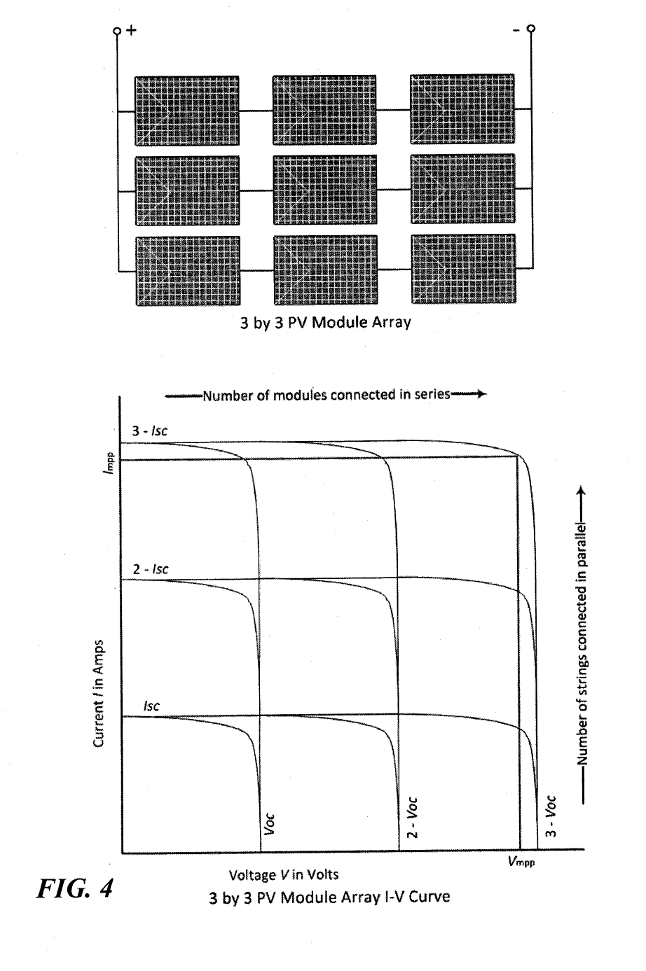

The current for the parallel modules equals the sum of the current produced for each module. The voltage is the average voltage produced by each module. FIG. 4 shows a PV array comprised of three parallel three-module strings and the I-V curve for this array if the modules each had identical performance characteristics. The shaded area represents the production of the array.

Currently, string monitoring is utilized in a small percentage of PV plants with arrays assembled in a configuration with N parallel M-length PV strings. String monitoring can detect the failure of a single string of modules and raise alarms. String measurements for multiple strings can be compared for the same time period to remove weather as the cause of production differences between strings. As the industry adopts research showing that wiring arrays as N-parallel M-length strings is not the most productive, string monitoring will need to be adapted.

A more complete as-built PV plant model capable of separating production variances caused by weather from production variances caused by equipment within the plant can be implemented. In one embodiment, the model can include expected and measured I-V curves at the string, sub-array and array levels to provide a base for production analytics and for production short-falls isolated by cause. The I-V curves are measured at the plant at plant acceptance testing and periodically during plant maintenance. The I-V curves can be taken with test equipment or by installing instrumentation on the plant. At plant acceptance testing, I-V curve traces can be run on a statistically significant set of array sub-assemblies, the test results can be recorded in the production model and relative baseline with mean and deviation of measured sub-arrays, also called sub-assemblies, can be established. As part of annual scheduled maintenance, I-V curve traces can be re-run on the same sub-assemblies, and these measurements can be stored in the production plant model. By entering baseline array measurements from test equipment and instrumentation into the system and updating these measurements with data from the monitoring system and scheduled maintenance testing, time-based changes to array production can be detected. Further, by comparing portions of the array with like portions and adjusting these comparisons by baseline measurements, “fuel” can be eliminated as a mask to production problems and equipment failures or degradations can be detected.

Production—As-Built PV-Plant Model Plus Performance Analytics Used to Measure Losses by Production Stage

The traditional applications used to estimate PV plant electricity production are based on simplistic models of the PV plant assembly. These models do not include all plant components so losses cannot be attributed to specific components; to compensate losses are modeled by subsystem as percentages. This approach makes it difficult to use actual performance measurements to improve the accuracy of the electricity production estimates. It also makes it difficult to attribute losses to their base cause.

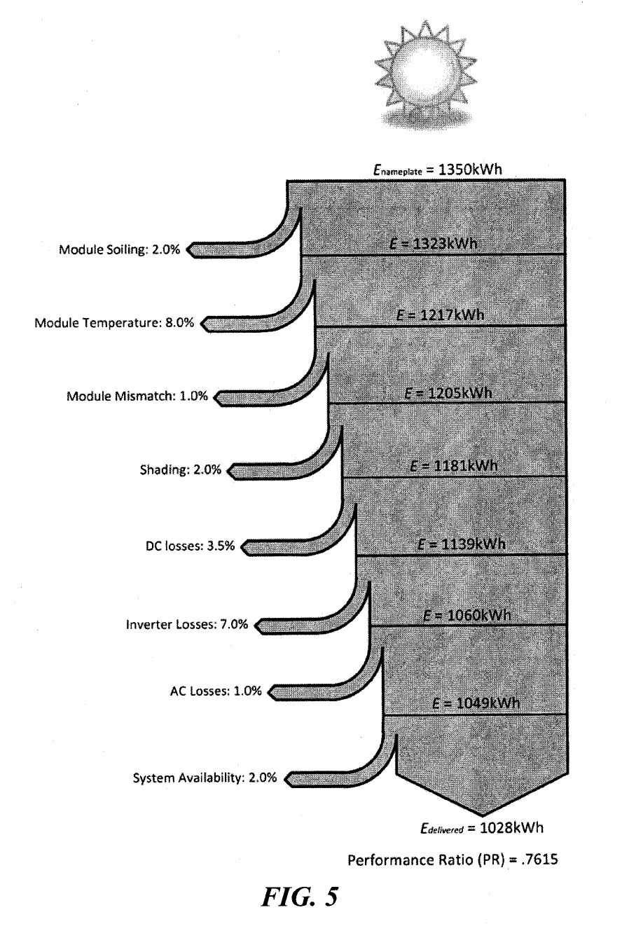

Some current PV modeling applications identify multiple causes for production losses in a PV plant and allow entry of the estimated losses for each cause as a percentage. Typically, the plant is modeled in stages as shown in FIG. 5, and losses can be estimated for each stage. In the example of FIG. 5 eight production stages with estimated losses are modeled; in the first stage, module soiling reduces electricity production by 2% making the plant only 98% efficient; production is further reduced in the second stage, the module temperature reduces the efficiency by an additional 8% making the plant only 90% efficient; and as shown each of the subsequent production stages further reduces efficiency with the result as shown in FIG. 5 of a plant that is 76.15% efficient. The as-built plants do not have instrumentation to measure the production of the stages as modeled so attributing production loss to the actual cause and adjusting the model does not occur.

Currently, string-level instrumentation and monitoring is used in a small percentage of plants. String monitoring is especially useful in detecting shading. Monitoring instruments might also include back-of-module temperature sensor to measure module temperature. Independent test labs that test PV modules in field conditions can be used to determine module nominal efficiency in real-world conditions. Unfortunately, this still leaves 5 to 8.5 percent production losses from module mismatch, maximum power point (MPP) mismatch and soiling that cannot be isolated, and enforcement of module degradation warranties and inverter efficiency warranties depend on isolating these root causes. The MPP is managed by the inverter, and MPP mismatch occurs when the inverter does not accurately determine the MPP or is slow to adjust the MPP in changing weather conditions. When MPP mismatch occurs, the result is production losses.

One solution is to implement an as-built PV plant model capable of modeling and measuring plant production at each production stage. In one embodiment, measurement data and advanced performance analytics is used to continually improve the accuracy of the model. In one embodiment, acceptance test measurements can be used to establish the model baseline.

By using a more complete as-built PV plant model that includes each component, the expected losses can be calculated more accurately and these losses can be adjusted based on actual measurements, where components are assembled into sub-assemblies and arrays. This improves the initial estimate of the as-built PV plant electricity production estimates and supports accuracy over time as the components degrade over time. By including the source of the data, for example, the type of instrumentation or test equipment, the physical test point locations, and the date and time of the measurements, and further, by including the measurements and accuracy of the instruments and test equipment in the components database and as-built model and by storing the measurements taken by the instruments and test equipment in the plant model database, the accuracy of PV plant electricity production estimates can be improved, and component failure or degradation can be detected. Additional performance analytics can utilize this data to detect changes in the plant production, both abrupt and gradual.

Production—As-Built PV Plant Model, Baseline Acceptance Test Measurement Plus Performance Analytics Used to Verify Equipment Performance Warranty

Many of the components, materials and workmanship in PV plants have warrantees, some for as long as 25 years, that cover performance degradation as well as failure. The PV plant monitoring applications and the PV plant instruments and physical tests are not designed to measure component warranty compliance. It is possible for component failures to occur without being detected for an extended period of time. In fact, it is likely that PV modules and inverters that operate outside their warrantied performance will never be detected. Plant production is reduced when failures are not detected quickly and when components that fail to operate as warrantied are not detected and repaired or replaced.

Typically, warranty of module degradation, inverter maximum power point (MPP) management and inverter efficiency are not enforced unless the degradation and/or inefficiency are extremely severe because they are difficult to measure and prove with current plant instrumentation and production analytics. Materials and workmanship warranties are enforced by visual inspections, but materials and workmanship that result in production losses are seldom detected.

One solution is to include the performance warranty metrics in the as-built PV plant model. In one embodiment, test equipment with sufficient accuracy is used to measure performance against warranty, and this equipment is also used during acceptance testing to establish the equipment performance baseline.

In one embodiment, by determining analytics needed to measure equipment performance against warrantied performance and the measurements and measurement accuracy needed by these analytics, equipment problems can be detected and repaired under warranty and the expected level of electric production maintained. In one embodiment, by using measured data to continually improve the accuracy of the production models and by storing detailed performance and measured data for the life of the plant, and by feeding this data to sophisticated analytics applications, equipment degradation can be measured.

Production—Predicting PV Module Plan Performance Over Varying Irradiance Levels and Temperatures

PV module performance is affected by irradiance and temperature. A typical PV power plant uses hundreds or thousands of PV modules, thus multiplying any adverse performance effects of the PV modules by hundreds or thousands of times. PV modules are tested by the manufacturer to standard test conditions (STC), and the results are published on the PV module data sheet. This published data is not adequate to accurately predict how the PV module will perform in an operating environment at a specific PV power plant. If the performance cannot be accurately predicted, then unexpected changes to the performance cannot be detected. Slow performance changes such as module degradation or dirt build-up are obscured until they exceed the prediction accuracy threshold.

PV plant modeling software uses the data from the manufacturer's data sheet as the basis for predicting PV module performance, and by extension, PV plant production. For plant feasibility analysis, the accuracy of this data is satisfactory. However, for power plant operation, using the same feasibility tools to assess the plant's performance achieves an accuracy no better than plus or minus ten percent (±10%).

Testing laboratories will test PV modules in field conditions that much more closely represent the actual conditions expected at the power plant than those represented by standard test conditions. Using the laboratory test data in the modeling tools increases the accuracy of the performance model slightly but still does not provide a method for detecting small failures or slowly developing performance degradation.

Mathematical models using measured data from the plant have also been used by some organizations to assess plant performance. These models add another tool if properly updated by known changes at the plant such as preventive maintenance or module cleaning and can improve the predictive model to tolerances of plus or minus five percent (±5%).

In one embodiment, the PV plant as-built can be modeled to determine expected performance at the output of each piece of equipment. Alternatively or additionally, the PV module performance can be modeled as a function of irradiance on the module and operating temperature of the module to increase the accuracy of predicting performance of the PV production module and to allow small and slowly developing degradations to be detected.

The energy generated by a PV module is determined by the irradiance on the face of the module and the operating temperature of the PV cells within the module. There are five coefficients that can be used to increase the accuracy of expected PV module performance relative to standard test conditions. The first coefficient, Cir, is the percentage change in short-circuit current for each watt-per-square-meter change in irradiance. The second coefficient, Cvr, is the percentage change in open-circuit voltage for each watt-per-square-meter change in irradiance. The third coefficient, Cit, is the percentage change in short-circuit current for each degree-Celsius change in cell operating temperature. The fourth coefficient, Cvt, is the percentage change in open-circuit voltage for each degree-Celsius change in cell operating temperature. The fifth coefficient, CTt, is the percentage change in cell operating temperature for each degree-Celsius change in ambient temperature. The use of any single coefficient would be beneficial to increasing the accuracy of the model; in particular, the fourth coefficient, Cvt, has the largest impact. However, the use of multiple coefficients can provide a greater improvement in the accuracy of expected PV module performance.

These five coefficients vary by site and are not constant for varying levels of irradiance or temperature. Using statistical methods and measured performance-to-date of module output voltage and current, each of these coefficients can be accurately derived for a specific plant and for a specific irradiance and temperature measurement. The NSAM application derives these coefficients for a specific plant across the operating irradiance and temperatures at the plant. Increasing the accuracy at the PV module level results in a very significant improvement to the accuracy of the calculations for the expected PV plant performance. These calculations become more accurate over time to permit the detection of small failures and slowly occurring degradation.

Finance—Financial Model of PV Plant Used to Value Plant Production

PV plant maintenance, repair and cleaning decisions are typically made based on cost alone or on the cost to revenue-loss trade-off. The loss to the PV plant owner of a plant needing repair or cleaning can be far greater than revenue-loss. Performance guarantees can trigger penalties, debt coverage ratio can require increased reserves, balancing authority settlements can include penalties, and the net-present-value of the plant can decline five-times the lost production.

Currently, the cost of plant maintenance is compared with the lost revenue; or the forecast production of the degraded plant is compared to the production guarantee, and the decision to repair the problem prior to scheduled maintenance is based only on these trade-offs.

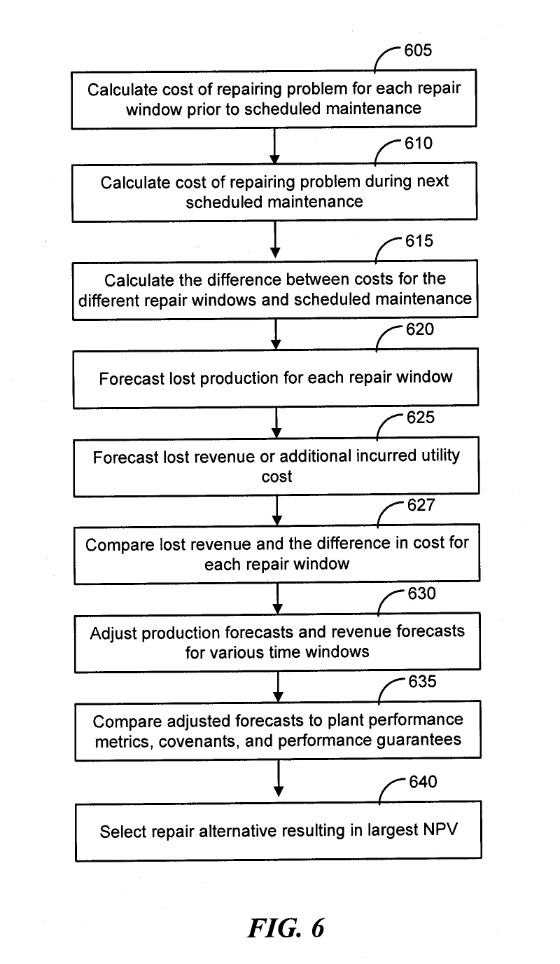

However, in one embodiment, a complete financial model of the PV plant can be implemented and used to value lost production. The results of the financial model can then be used to provide value-driven advice to plant management for making decisions regarding activities such as plant maintenance, repair and cleaning. FIG. 6 depicts a flow chart illustrating an example process for making decisions regarding plant activities based on a financial model.

At block 605, calculate the cost of repairing the problem for each repair window prior to the next scheduled maintenance. Then at block 610, calculate the cost of repairing the problem during the next scheduled maintenance. Next, at block 615, calculate the difference between the costs for the first and second scenarios. For example, possible repair windows can include the present time when a problem arises (“immediate”) and when the PV plant produces a minimum of power at night (“off-hours”). Then a difference in the costs of repairs for these two repair windows is calculated as follows.

Δ_{immediate}=Cost_{immediate}=Cost_{scheduled}

Δ_{off-hours}=Cost_{off-hours}−Cost_{Scheduled}

At block 620, forecast the production lost with the capacity offline until each repair time plus the production lost while making the repair for each repair time costed at block 605. Off-hours repair or off-season scheduled repair should result in lower production lost while making the repair.

Next, at block 625, forecast the revenue lost or additional utility cost incurred until the repair is completed by using the forecast production losses calculated at block 620. Non-limiting examples of lost revenue include the direct power purchase agreement (PPA) revenue lost or the tariff-based increased utility cost to the electricity customer, the performance-based incentives lost, and the estimated selling price of the renewable energy credit (REC) lost.

Then at block 627, compare the revenue lost for each repair alternative identified at block 605 and compare with the delta cost of the repair. This step can also be based on the lost revenue and delta cost without explicitly comparing the lost revenue and delta cost for each alternative.

At block 630, adjust the production forecasts and revenue forecasts for day, week, month, quarter, and year. Then at block 635, compare these adjusted forecasts to the plant performance metrics, covenants, and performance guarantees. Determine if any of these obligations are endangered by delaying the repair. Forecast the net present value (NPV) of the plant using the adjusted operating forecast and compare with the plant performance metrics for each repair alternative. At block 640, select the repair alternative resulting in the largest NPV.

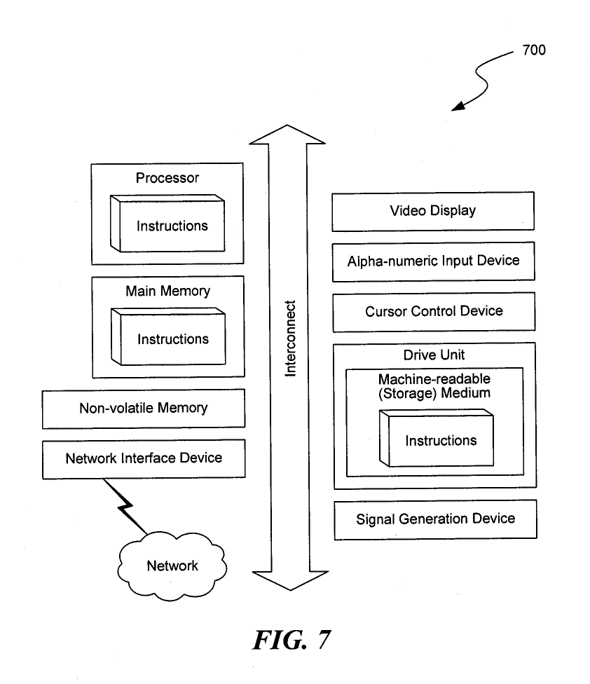

FIG. 7 shows a diagrammatic representation of a machine in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a personal digital assistant (PDA), a smart phone, a processor, a console, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 700 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

### NeoZyte Market Exchange

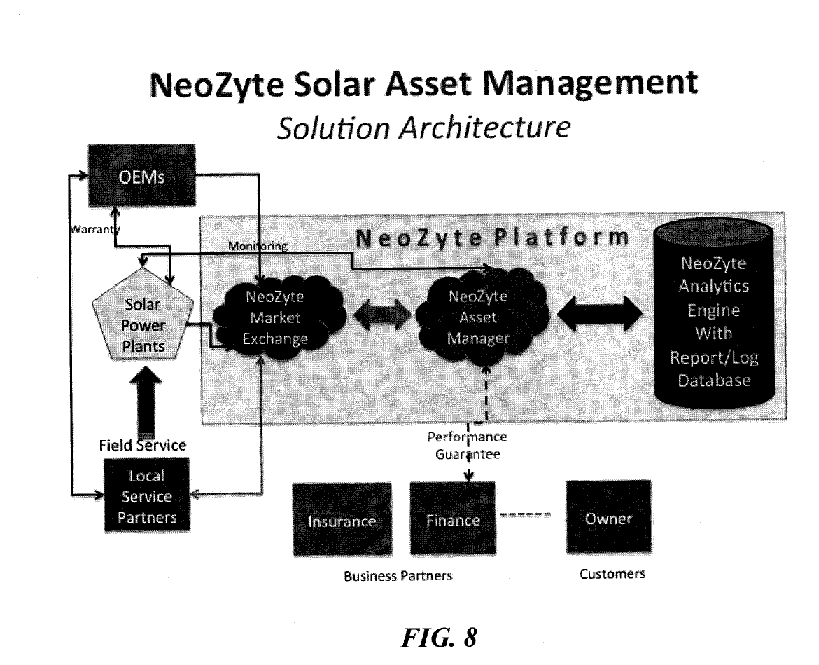

The NeoZyte Market Exchange is a secure Web 2.0-based platform designed to advantageously bring together the different stakeholders operating in the solar industry and connect them. The NeoZyte Market Exchange (NMEx) integrates with the NeoZyte Solar Asset Manager architecture (shown in FIG. 1) that implements many functionalities and business processes as depicted in FIG. 8. The resulting overall solution architecture is the NeoZyte Platform.

Original equipment manufacturers (OEM) routinely have warranty repairs and factory recalls generally serviced by their support staff. However, many OEMs are increasingly finding that maintaining a permanent support staff on its payroll for servicing a geographically diverse customer base can be a very costly proposition. They are looking for outside qualified service providers to reduce their support cost in a business where profit margins are shrinking.

Firms that perform engineering, procurement, and construction (EPC) are routinely left with providing operations and maintenance (O&M) services to the plants they build. Even though their core business is in building plants, they are continually finding that O&M is becoming a prohibitive cost center for them as they routinely under-budget for O&M services. They are looking for outside qualified service providers to reduce their support cost in a shrinking profit margin business. Furthermore, sometimes they have idle support staff who can potentially be utilized for providing O&M services for plants owned by others.

At the same time, there are many qualified independent and small service providers who are looking for customers. However, the resources they have available to them are typically traditional job search methods, such as word of mouth, newspapers, Internet search, etc. Many times the opportunity to provide a service is lost by the time they become aware of it. Larger service providers may also be seeking a better way to enlarge their customer base.

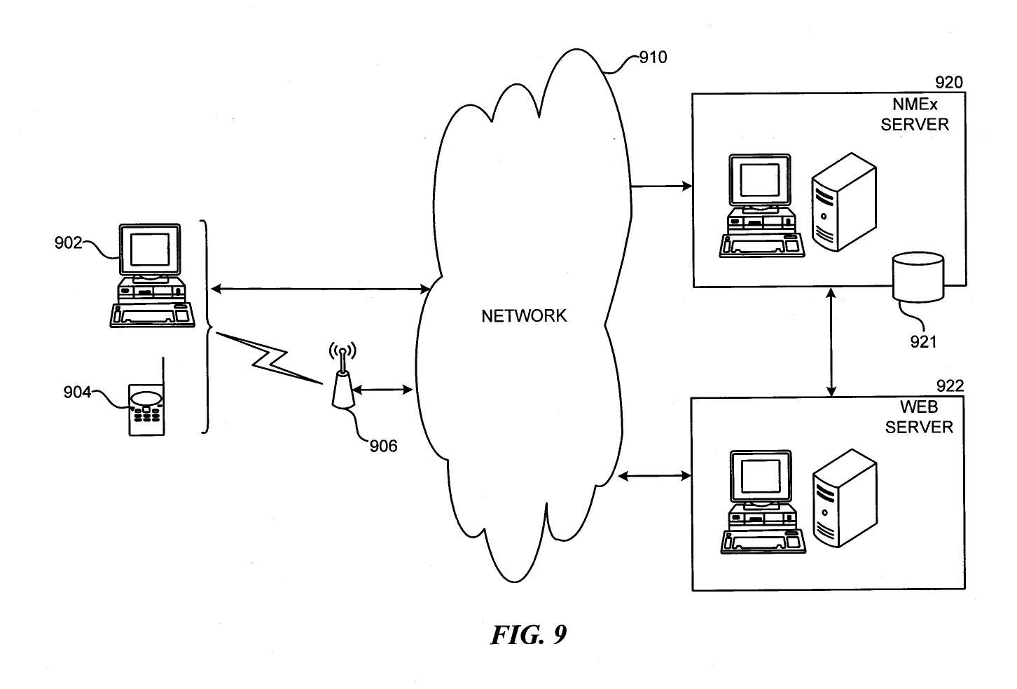

Techniques are described herein for interacting with the NMEx. FIG. 9 and the following discussion provide a brief, general description of a representative environment in which the techniques described herein can be implemented. Although not required, aspects of the disclosure may be described below in the general context of computer-executable instructions, such as routines executed by a general-purpose data processing device (e.g., a server computer or a personal computer). Those skilled in the relevant art will appreciate that the techniques can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the disclosure, such as certain functions, are described as being performed exclusively on a single device, the techniques can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the disclosure may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the disclosure may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 9, a user may use a personal computing device (e.g., a mobile computing device 904, a personal computer 902, etc.) to execute functionalities for the techniques described herein. The user may also use the personal computing device to communicate with a network. The term “mobile computing device,” as used herein, may be a laptop, a netbook, a personal digital assistant (PDA), a smart phone (e.g., a Blackberry®, an I-phone®, etc.), a portable media player (e.g., an IPod Touch®), or any other device having communication capability to connect to the network. In one example, the mobile computing device 904 connects to the network using one or more cellular transceivers or base station antennas (not shown in FIG. 9), access points, terminal adapters, routers or modems 906 (in internet protocol (IP)-based telecommunications implementations), or combinations of the foregoing (in converged network embodiments).

In some instances, the network 910 is the Internet, allowing the personal computing device to access functionalities offered through, for example, the NMEx server 920 or various web servers. In some instances, the network is a local network maintained by a private entity or a wide area public network, or a combination of any of the above types of networks. In some instances, especially where the mobile computing device 904 is used to access web content through the network 910 (e.g., when a 3G or an LTE service of the phone 902 is used to connect to the network 910), the network 910 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

In some instances, the NMEx is hosted on an NMEx server 920. In such an instance, the NMEx is run similar to a web or internet service in conjunction with a web server 922. As explained above, a user may use a personal computing device to connect to the NMEx server 920 using the network (e.g., a local office network, the Internet, etc.). In an illustrative example of such an instance, the user would use the personal computing device to submit a request for quote (RFQ) for services related to the solar industry or to respond to an RFQ with a quote. The NMEx server 920 receives an RFQ and distributes the RFQ to suitable registered service providers who meet criteria specified by the creator of the RFQ. Subsequent to distributing the RFQ, the NMEx server 920 receives RFQ quotes from service providers and forwards them to the RFQ creator. In some instances, the NMEx server 920 may, by itself, operate as a web server to receive and transmit RFQs and quotes using standard web protocols. In other instances, the NMEx server 920 may be coupled to a web server 922, where the NMEx server 920 performs the various RFQ-related services, while the web server 922 enables the transmission and reception of RFQs and quotes using standard web protocols.

The NMEx server 920 can access a local NMEx database(s) 921 that contains information used by the NMEx server 920, for example, service provider contact information and qualifications and preferred mode of contact for the service providers. In fact, the database 921 can serve as a service provider network that can be accessed and used advantageously by the NSAM, for example, for managing service tickets. In some instances, the database(s) 921 is accessed over the network 910. The database 921 can include a single database or multiple separate databases.

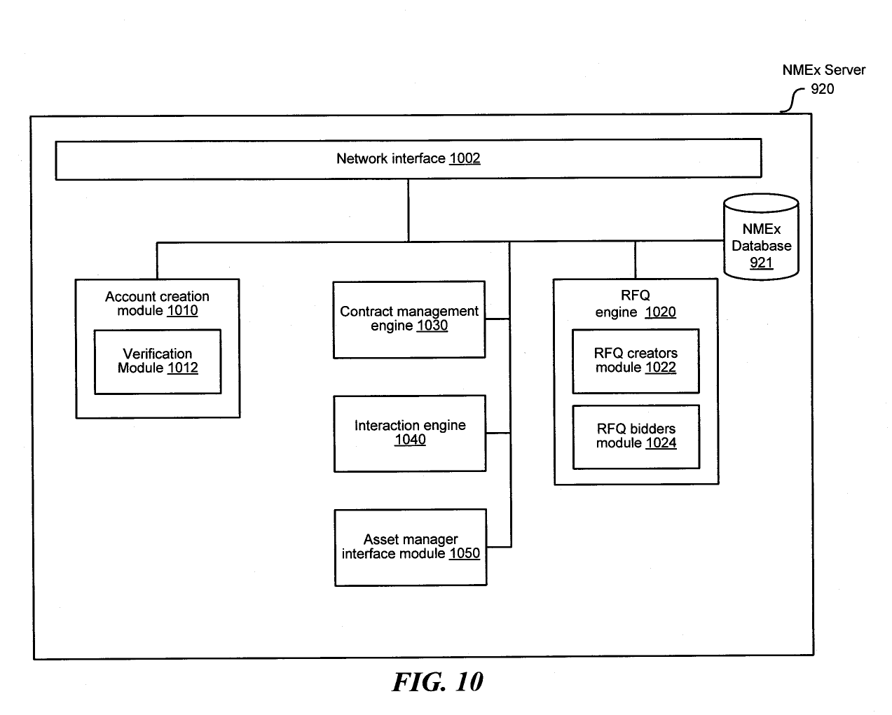

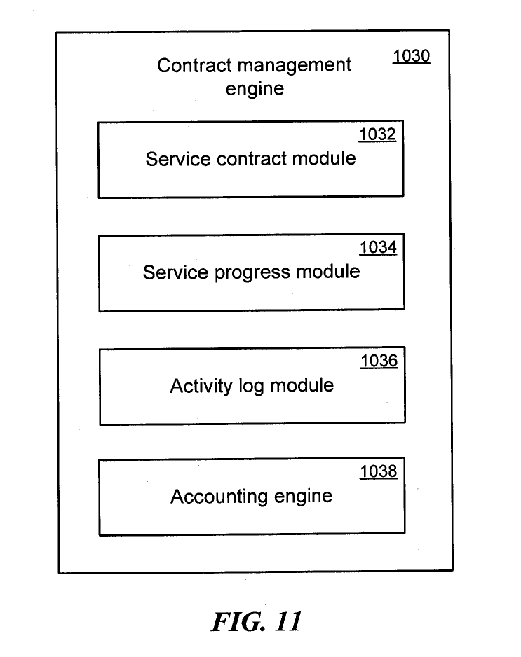

Functions and techniques performed by the NMEx server 920 and the related components therein are described, respectively, in detail with further reference to the examples of FIGS. 10 and 11.

FIG. 10 depicts a block diagram illustrating an example of components in the NMEx server 920 that support the NMEx. The NMEx server 920 can include, for example, a network interface 1002, an account creation module 1010, an RFQ (request for quote) engine 1020, a contract management engine 1030, an interaction engine 1040, and an asset manager interface module 1050. Additional or fewer components/modules/engines can be included in the NMEx server 920 and each illustrated component.

The network interface 1002 can be a networking module that enables the NMEx server 920 to mediate data in a network with an entity that is external to the NMEx server 920, through any known and/or convenient communications protocol supported by the host and the external entity. The network interface 1002 can include one or more of a network adaptor card, a wireless network interface card (e.g., SMS interface, WiFi interface, interfaces for various generations of mobile communication standards including but not limited to 1G, 2G, 3G, 3.5G, 4G, LTE, etc.,), Bluetooth, a router, an access point, a wireless router, a switch, a multilayer switch, a protocol converter, a gateway, a bridge, bridge router, a hub, a digital media receiver, and/or a repeater.

In one embodiment, the NMEx server 920 includes an account creation module 1010 that creates user accounts with the NMEx. Examples of types of users of the NMEx who can register with the account creation module 1010 include plant owners, OEMs, EPCs, and service providers. In one embodiment, the users who register with the account creation module 1010 are permitted to select a secure login identification and password, so that users can customize their experience with the NMEx, maintain their privacy, and pay for NMEx services, where NMEx services include access to services provided by NSAM.

Users who register with the account creation module 1010 can submit an RFQ, submit a quote for an RFQ, and access discussion forums, analytic tools designed for photovoltaic plants, and services provided by the Analytics/Analysis Engine (AAE), Decision Support System Manager (DSSM), or any other module of the NeoZyte Solar Asset Manager (NSAM).

Users who will generate an RFQ for submission to the NMEx should provide information including name of company; location; point of contact information; preferred mode of communication, such as email, instant messaging, or telephone; and source of payment for NMEx services. Users who are service providers and want to respond to RFQs submitted to the NMEx with quotes should also provide qualifications and any documented reviews/ratings from previous customers and/or certifying authorities.

In one embodiment, the qualifications provided by service providers are automatically verified by the verification module 1012. The verification module 1012 is configured to verify with certified authorities whether a service provider has been certified and optionally the level of certification of the service provider. In one embodiment, the qualifications are manually verified and entered in the database 921.

Account information, registration information, and verification information are stored in the NMEx database 921 that can be local to the NMEx server 920 or accessible over a network 910.

One embodiment of the NMEx server 920 includes the RFQ engine 1020 which is configured to receive RFQs from RFQ creators, distribute the RFQs to service providers who meet certain criteria set by the RFQ creator, and receive RFQ bids from service providers. In one embodiment, the RFQ engine 1020 can include an RFQ creator module 1022 and an RFQ bidder module 1024.

In one embodiment, the RFQ creator module 1022 is configured to receive an RFQ from an RFQ creator. The RFQ can include RFQ parameters such as the details of the photovoltaic plant to be serviced and a description of the problem. The RFQ can also include criteria of service providers that the RFQ should be sent out to, or whether the RFQ should be posted to all service providers registered with the NMEx. Based on the RFQ criteria, the RFQ creator module 1022 identifies registered service providers who meet the criteria and sends the RFQ to those service providers. The RFQ creator module 1022 is configured to send the RFQ to the service providers according to the preferred mode of communication selected during registration.

The RFQ creator module 1022 can also accept questions from the RFQ creator about any quotes submitted by a service provider and forward the questions to the relevant service provider. Further, the RFQ creator module 1022 can also accept supplemental information provided by an RFQ creator in response to questions from a service provider about an RFQ and forward the supplemental information to the service provider.

In one embodiment, the RFQ bidder module 1024 is configured to receive RFQ quotes from service providers to whom an RFQ is distributed. The RFQ bidder module 1024 can also accept questions from service providers pertaining to an RFQ and forward the questions to the RFQ creator. Further, the RFQ bidder module 1024 can also accept supplemental information provided by a service provider in response to questions submitted by an RFQ creator in response to a quote and forward the supplemental information to the RFQ creator.

One embodiment of the NMEx server 920 includes the contract management engine 1030 which is responsible for maintaining details related to a service contract agreement between an RFQ creator and a service provider. In one embodiment, the contract management engine 1030 can include a service contract module 1032, a service progress module 1034, an activity log module 1036, and an accounting engine 1038, as shown in FIG. 11.

Once the RFQ creator and a service provider have agreed to the terms of a service agreement, the service contract module 1032 can generate a service contract for the agreed upon services and issue a purchase order (PO).

The service progress module 1034 is configured to communicate with the service provider and provide service progress updates to the RFQ creator, for example, if parts need to be ordered, the updates can include the amount of time before the parts arrive. When the service provider reports completion of the agreed upon services to the service progress module 1034, the service progress module 1034 can send the information to the RFQ creator.

Further, if a disagreement arises between the service provider and the RFQ creator, the service progress module 1034 can notify a third party registered with the NMEx server 920 to act as an independent, unbiased third party for facilitating conflict resolution.

The activity log module 1036 is configured to maintain a log of all service-related activities, including the dates when problems arise at a photovoltaic plant, the dates when the services are completed and by whom, and dates when new parts are ordered and installed. The information can be used for auditing purposes and/or for warranty purposes.

The accounting engine 1038 is configured to integrate with accounting systems of the RFQ creator and/or the service provider. The accounting engine 1038 can receive the bills directly from the accounting department of the service provider and send it on as an invoice directly to the accounting department of the RFQ creator.

One embodiment of the NMEx server 920 includes the interaction engine 1040 which provides various methods for registered users to communicate with each other. Methods can include, but are not limited to, an online discussion forum for solar industry-related topics, emailed messages, instant messaging, and community boards.

One embodiment of the NMEx server 920 includes the asset manager interface module 1050 configured to interface with the NeoZyte Solar Asset Manager (NSAM). For example, the service ticketing system manger (STSM) module and guaranty ticketing system manager (GTSM) module of the NSAM benefit from integration with a service providers' network, and the NMEx server 920 registers service providers. Thus, the interface module 1050 provides access to the network of registered service providers for the NSAM. Further, the NSAM can interact with the asset manager interface module 1050 to access the NMEx server 920 for managing a service ticket or guaranty ticket.

In one embodiment, the asset manager interface module 1050 can also be used by the NSAM to communicate through the NMEx server 920 with plant owners, OEMs and EPCs using a variety of media including the internet and mobile devices.

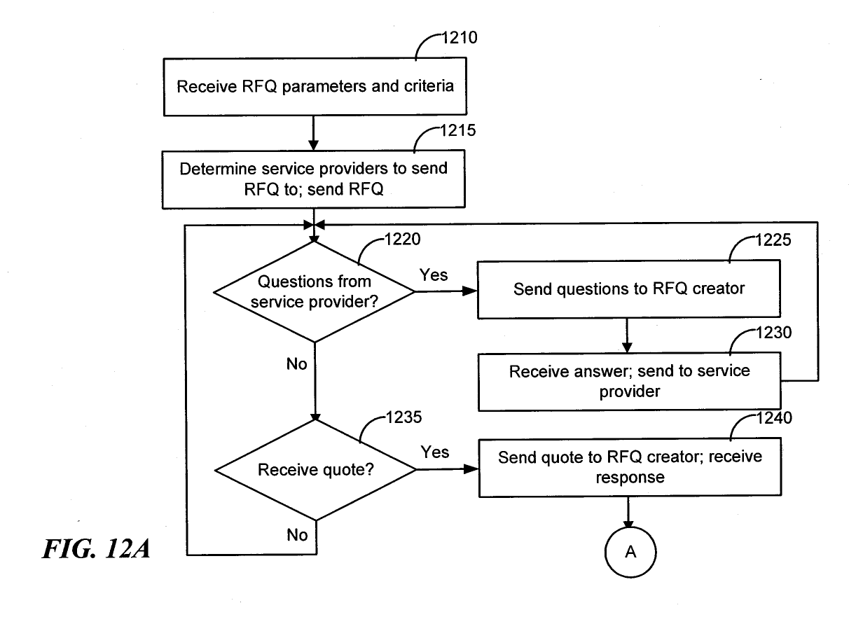

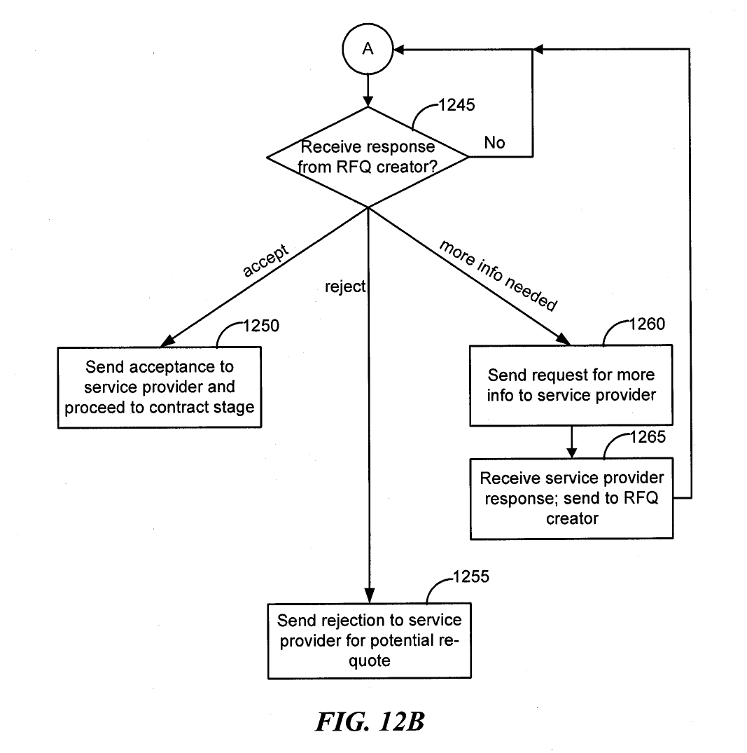

FIGS. 12A and 12B depict a flowchart illustrating an example process of receiving an RFQ for distributing to service providers and receiving RFQ quotes. At block 1210, the system receives RFQ parameters and criteria from an RFQ creator, for example, a plant owner, an OEM, or an EPC who needs a photovoltaic plant-related service provided. RFQ parameters can include, but is not limited to, the details of the photovoltaic plant to be serviced; a description of the problem; the type of service needed, if known; and a price range, if any; a date and/or time for which the service should be completed by. The RFQ creator can also specify service provider criteria to whom the RFQ should or should not be sent. For example, the RFQ creator can specify service provider qualifications, proximity of the service provider to the plant, the size of the service provider, a minimum rating for the service provider, and names of service providers to contact or not contact.

Then at block 1215, the system compares the criteria specified by the RFQ creator against the information in the database 921 about the service providers registered with the NMEx server 920 and determines the service providers who should and should not be contacted. The system sends the RFQ to the identified service providers. In one embodiment, the system distributes the RFQ in the manner specified by the RFQ creator. In one embodiment, the system distributes the RFQ in all available manners of distribution, for example, by instant message or email. In one embodiment, if the RFQ creator does not limit the recipients of the RFQ, the system can post the RFQ to a community board hosted by the NMEx server 920.

At decision block 1220, once the RFQ has been distributed, the system determines whether there are any questions about the RFQ from any service providers. If there are questions (block 1220—Yes), at block 1225, the system sends the questions to the RFQ creator by email. Alternatively or additionally, if the RFQ creator specified a preferred mode of communication in the RFQ creator's registration profile, that mode should be used. Then at block 1230, when the system receives an answer to the questions, the system sends the answer to the service provider by email or a specified mode of communication. The process returns to decision block 1220.

If there are no questions (block 1220—No), at decision block 1235, the system determines if an RFQ quote has been received. If no quotes have been received (block 1235—No), the process returns to decision block 1220. If a quote is received (block 1235—Yes), at block 1240, the system sends the quote to the RFQ creator and waits for a response.

Then at decision block 1245, the system determines whether a response has been received from the RFQ creator. If no response has been received (block 1245—No), the process waits at decision block 1245. If the system receives an acceptance of the quote from the RFQ creator (block 1245—accept), at block 1250 the system sends the acceptance to the service provider, and the two parties proceed to the stage of forming a contract. If the system receives a rejection of the quote form the RFQ creator (block 11245—reject), at block 1255 the system sends the rejection to the service provider who can choose to submit another quote to the RFQ creator.

If the system receives a request for more information from the service provider (block 1245—more information), at block 1260 the system sends the request to the service provider. Then at block 1265, the system receives the information from the service provider and forwards the information to the RFQ creator. The process returns to decision block 1245 where the system waits for a response from the RFQ creator.

Alternatively, or additionally, the system can place the RFQ creator and service provider in contact with each other, and they can directly negotiate the terms of a service contract agreement.

### CONCLUSION

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while photovoltaic plants are discussed, the techniques presented herein regarding the plant asset management platform can also be applied to other industrial plants. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention. For example, while the NMEx server 920 is described herein as a platform for entities involved in the solar industry, the NMEx server 920 can alternatively or additionally be used as a platform for entities associated with other industries, such as wind power or other renewable energy sources.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

We claim:

1. A market exchange system comprising:
at least one memory component storing a software program;
at least one database, wherein the database includes service provider information;
a processor coupled among the memory component and the database,
wherein the processor is configured to execute the software program,
the software program comprising:
a first module operable to register service providers that provide services to a solar industry and entities requiring services related to the solar industry;
a second module operable to receive a request for quote (RFQ) from one of the entities requiring services and distributing the RFQ to at least a subset of the service providers.

2. The system of claim 1, wherein the software program executed by the processor further comprises a third module operable to compare service provider criteria provided by the one of the entities to information provided by the service providers during registration to select the subset of the service providers to send the RFQ to.

3. The system of claim 2, wherein the service provider criteria include certification by a certifying authority for solar industry-related services.

4. The system of claim 1, wherein the second module is further operable to receive a quote for the RFQ from one of the subset of the service providers and send the quote to the one of the entities.

5. The system of claim 4, wherein the software program executed by the processor further comprises a fourth module operable to perform contract management services between the one of the entities and the one of the subset of the service providers.

6. The system of claim 1, wherein the software program executed by the processor further comprises a fifth module operable to provide an online discussion forum for solar industry-related topics.

7. The system of claim 1, wherein the software program executed by the processor further comprises a sixth module operable to facilitate interactions between registered entities and a photovoltaic asset management platform, wherein the platform evaluates equipment and operations of a photovoltaic plant to identify a course of action to optimize operation of the plant.

8. The system of claim 7, wherein the platform further models performance of the plant to identify a failure or degradation of components within the plant.

9. A method comprising:
registering by a server a first plurality of entities and a second plurality of entities associated with a photovoltaic industry, wherein the first plurality of entities seek photovoltaic energy generation-related services, and wherein the second plurality of entities provide photovoltaic energy generation-related services;
accepting by the server a request for quote (RFQ) for a first photovoltaic energy generation-related problem from one of the first plurality of entities;
distributing by the server the RFQ to at least a subset of the second plurality of entities.

10. The method of claim 9, further comprising identifying the subset of the second plurality of entities for distribution of the RFQ to by matching RFQ service provider criteria provided by the one of the first plurality of entities to information provided by the second plurality of entities during registration or a qualification verification authority.

11. The method of claim 10, wherein service provider criteria include certification by a certifying authority for photovoltaic industry-related service providers.

12. The method of claim 9, further comprising receiving a quote for the RFQ from one of the subset of the second plurality of entities and sending the quote to the one of the first plurality of entities.

13. The method of claim 12, further comprising receiving a question about the quote form the one of the first plurality of entities and sending the question to the one of the subset of the second plurality of entities.

14. The method of claim 9, further comprising receiving a question about the RFQ from one of the subset of the second plurality of entities and sending the question to the one of the first plurality of entities.

15. The method of claim 9, wherein distribution of the RFQ is by a selected method indicated by each of the subset of the second plurality of entities during registration.

16. The method of claim 9, wherein registration by the first and second plurality of entities provides access to services provided by a photovoltaic asset management platform.

17. The method of claim 9, further comprising maintaining a database of service providers from information provided during registration by the second plurality of entities.

18. A method comprising:
maintaining a database of photovoltaic-related service providers;
modeling performance of a photovoltaic plant to identify a problem within the plant;
selecting a service provider from the database of service providers to service the problem.

19. The method of claim 18, further comprising implementing a service ticket for the problem and managing the life of the service ticket until resolution of the problem.

20. The method of claim 18, wherein the database includes information on qualifications of the service providers that have been certified by a certifying authority.
